(19) United States
(12) Patent Application Publication
(10) Pub. No.: US 2011/0278088 A1
(43) Pub. Date: Nov. 17, 2011

(54) STEERING SYSTEM FOR THREE-WHEEL RIDE-ON LAWNCARE APPARATUS

(76) Inventors: Rick A. Weihl, Muskegon, MI (US); Chris Robbins, Muskegon, MI (US)

(21) Appl. No.: 12/781,156

(22) Filed: May 17, 2010

(51) Int. Cl. B62D 7/06; B62D 1/16

(52) U.S. Cl. 180/400; 280/92; 280/779

(57) ABSTRACT

A self-powered ride-on apparatus includes a frame with two front fixed-axis wheels and a single rear steerable wheel, a functional component such as a blower on the front, a motor for powering the blower and for motivating the apparatus, a platform on the frame to support a riding operator, and a steering mechanism. The steering mechanism includes a control head pivoted to the frame by a support and includes a handle for operating the motor speed. By pivoting the control head from side to side, an operator standing on the frame and positioned immediately adjacent the support can steer the equipment by moving the control head laterally to steer the apparatus into the corner while simultaneously leaning into the corner for balance and also while continuing to control operation of the one functional component via the handle.

### BACKGROUND

The present invention relates to lawn care apparatus such as ride-on blowers and other ride-on equipment for lawn care and outdoor use. However, the present invention is not believed to be limited to lawn care, but instead it is contemplated that it may be used on any ride-on outdoor equipment.

Heavy-duty lawn care equipment/apparatus, such as mowers, leaf and debris blowers, and the like, must be constantly steered, since lawns usually are irregularly shaped and include a variety of vegetation for aesthetics and other structures (e.g., sheds, play equipment, pet houses, etc). The need for constant steering can become burdensome and tiring after a long day, especially when repeated sharp turns are required in order to work closely around bushes and vegetation without damaging them. An improvement is desired to make constant steering and sharp steering easier to do, more ergonomic, and actually fun.

Stand-up ride-on mowers and blower equipment/apparatus are used by many (perhaps most) good-sized lawn care companies since the rider does not have to walk along behind the equipment. This makes the workers more efficient and ultimately helps them do a better job. However, controlling the equipment can be difficult and can result in significant effort in order to steer/turn the apparatus. As noted above, an improvement is desired to make the steering easier to do, more ergonomic, and actually fun.

### SUMMARY OF THE PRESENT INVENTION

In one aspect of the present invention, a self-powered ride-on apparatus includes a frame with at least two fixed-axis wheels and at least one steerable wheel, a functional component and a motor component supported on the frame, a platform on the frame adapted to support a riding operator, and a steering mechanism. The steering mechanism includes a control head and a pivoted support supporting the control head. The control head includes a handle constructed and operably connected to one of the functional component and the motor component, and is adapted to control operation of at least one aspect of the one component. The support is pivoted to the frame for side to side movement about an axis of rotation extending forwardly and generally horizontally. The support includes an upper first portion supporting the control head, a second portion pivoted to the frame and defining the axis of rotation in a location spaced from the control head, and a third portion spaced from the second portion and operably connected to the steerable wheel for steering same so that by moving the head laterally, steering of the steerable wheel is controlled. By this arrangement, an operator standing on the frame and positioned immediately adjacent the support can control steering of the equipment by the side to side movement of the support while also controlling operation of the one component via the handle.

In another aspect of the present invention, a self-powered ride-on apparatus includes a wheeled frame having at least one steerable wheel and constructed to support a ride-on standing operator, and a steering mechanism on the wheeled frame. The steering mechanism includes a support pivoted to the frame for side to side movement and a control head at a top of the support with controls for controlling a function of the apparatus. The support has a length positioning the control head and controls at a height for grasping by the standing operator. The support is operably connected to the at least one steerable wheel so that the side to side movement of the support causes the at least one steerable wheel to change a direction of rolling movement. By this arrangement, the standing operator can control steering of the equipment by moving the control head from side to side while also simultaneously operating the controls.

In another aspect of the present invention, a self-powered ride-on apparatus includes a wheeled frame having at least one rear-located steerable wheel and a pair of fixed-axis front wheels, a platform for a ride-on standing operator, a motor on the frame, a functional component on a front of the frame that is operably connected to the motor, and a control head operably supported on the frame. The control head is adapted for controlling at least one function on the functional component and further is operably connected to the steerable wheel for changing a direction of rolling movement of the steerable wheel when the control head is shifted laterally from side to side on the wheeled frame. In a narrower form, the at least one steerable wheel includes a single steerable wheel.

In another aspect of the present invention, an outdoor self-powered apparatus includes a wheeled outdoor self-powered equipment including a frame with a place for an operator to stand, a steering mechanism, at least one steerable wheel and a functional component. The steering mechanism includes a support pivoted to a frame generally adjacent a knee of the operator when standing thereon and includes an upper end with a place for the operator to grip, and includes a lower end connected to the at least one steerable wheel. By this arrangement, the operator can control steering by leaning into a corner while simultaneously moving the upper end of the support toward the corner, thus creating a stable lean-into type steering action for steering the apparatus.

In another aspect of the present invention, a method of steering and controlling an apparatus includes providing a wheeled outdoor self-powered equipment with a frame having a place for an operator to stand, a steering mechanism, at least one steerable wheel and a functional component. The steering mechanism includes a support pivoted to a frame generally adjacent a knee of the operator when standing thereon and includes an upper end with a place for the operator to grip, and includes a lower end connected to the steerable wheel. The method includes a step of steering by the operator leaning into a corner while simultaneously moving the upper end of the support toward the corner, thus creating a stable lean-into type steering action for steering the apparatus.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of an apparatus embodying the present invention.

FIGS. 2-3 are rear and top views of FIG. 1.

FIG. 4 is an enlarged fragmentary view of a lower end of the post support of the present steering mechanism.

FIG. 5 is a side view of FIG. 1, and FIG. 5A is an enlarged view of the head on the post support.

FIGS. 6-8 are perspective, rear and top views of FIG. 1 with the steering mechanism (including the steering head) being tilted toward a right turn (when moving forward).

FIG. 9 is an enlarged fragmentary view of the lower end of the post support of the present steering mechanism (while steering to make a right turn).

FIGS. 10-12 are perspective, rear and top views of FIG. 1 with the steering mechanism (including the steering head) being tilted toward a left turn (when moving forward).

FIG. 13 is an enlarged fragmentary view of the lower end of the post support of the present steering mechanism (while steering to make a left turn).

### DETAILED DESCRIPTION OF PREFERRED EMBODIMENTS

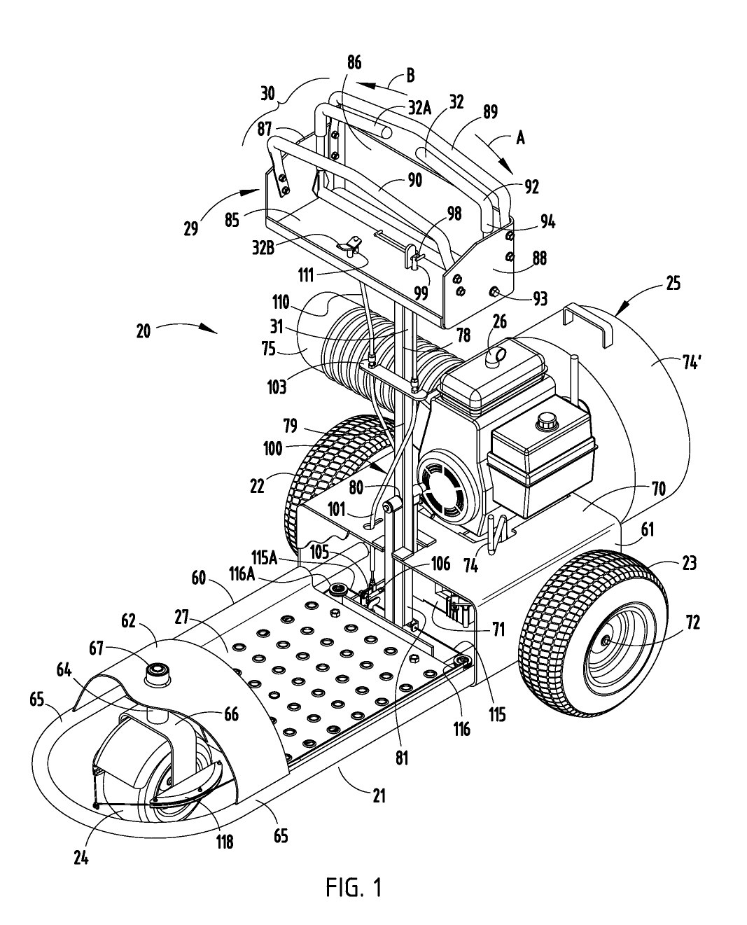

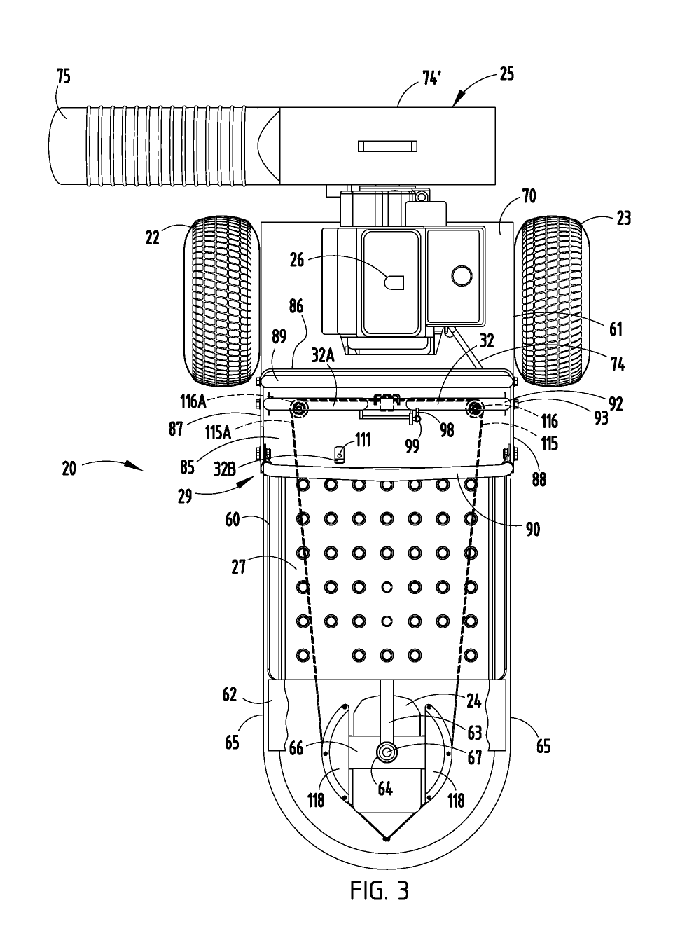

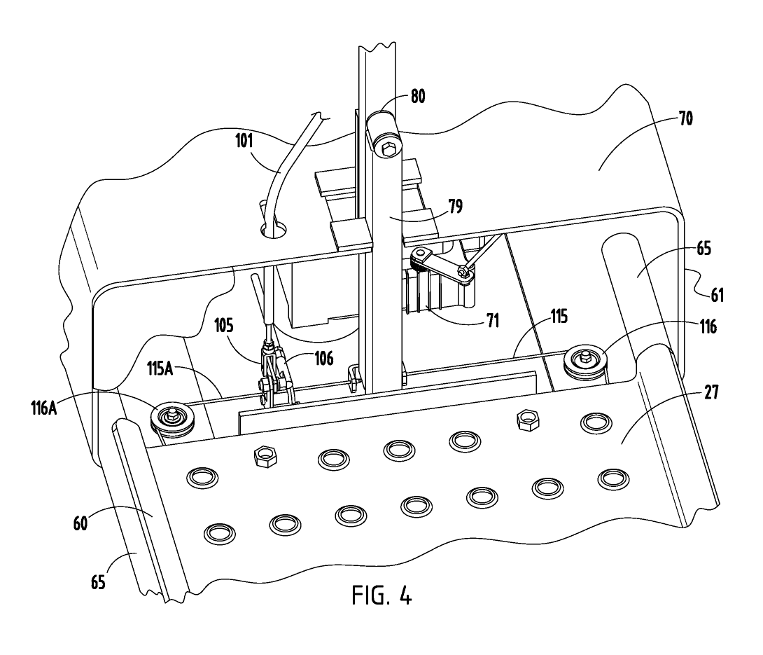

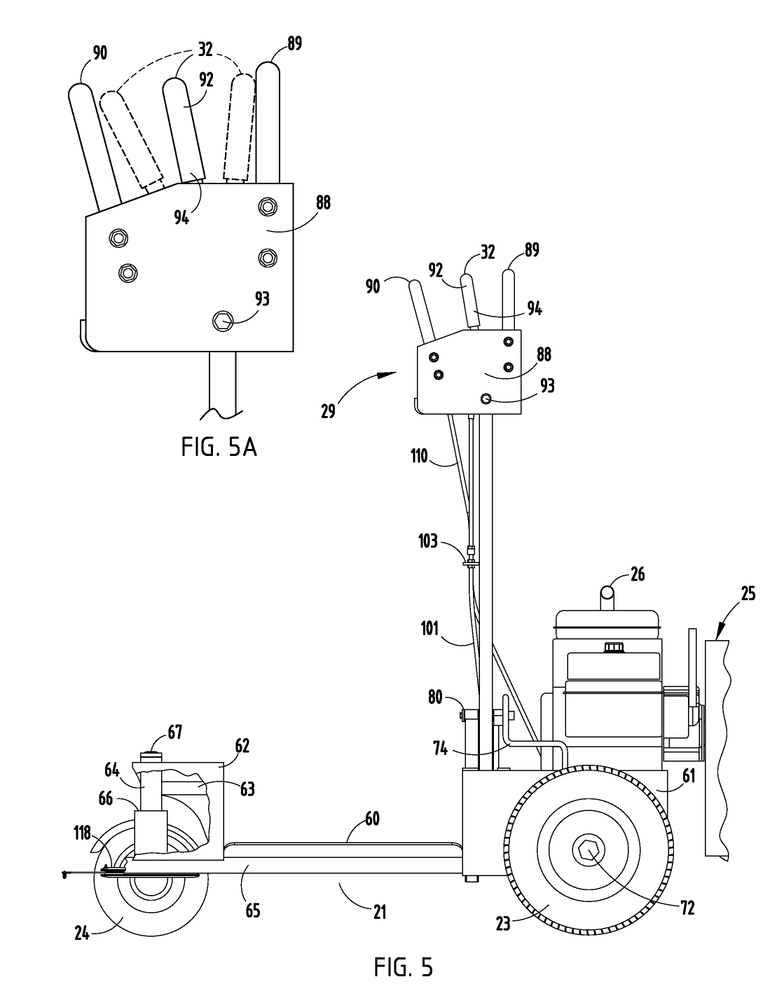

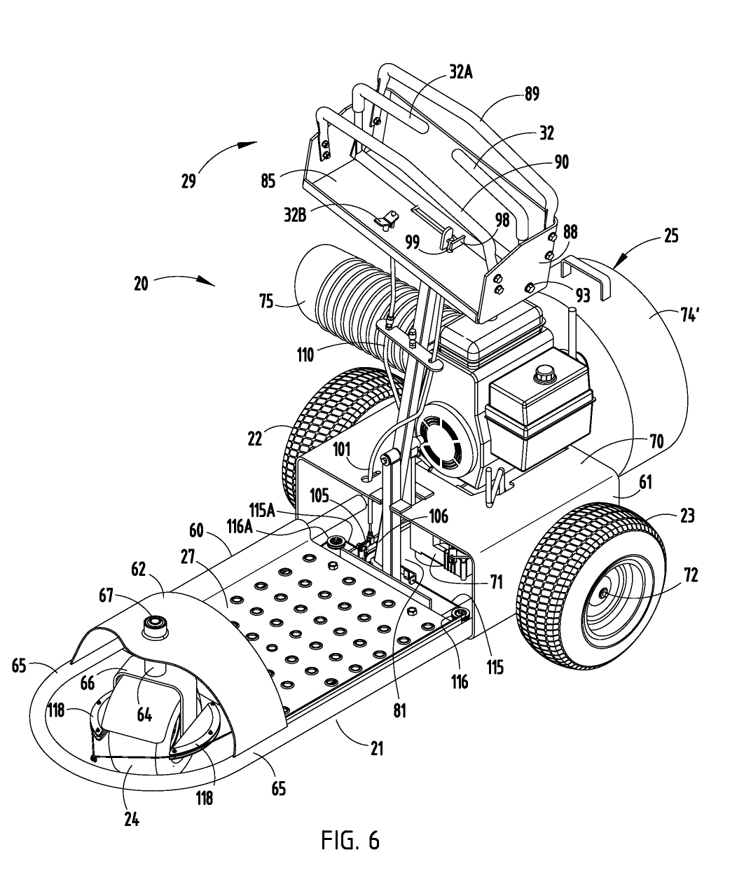

A self-powered ride-on apparatus 20 (FIGS. 1-3) includes a frame 21 with two front fixed-axis wheels 22, 23 and a single rear steerable wheel 24, a functional component such as a blower 25 on the front, a motor 26 for powering the blower 25 and for motivating the apparatus 20, a platform 27 on the frame 21 to support a riding operator 28, and a steering mechanism 29. The steering mechanism 29 includes a control head 30 supported by a post-like support 31 that is pivoted to the frame 21 at a pivot location that is about knee-high. The control head 30 includes a control such as the illustrated handles 32, 32A, 32B for controlling functions of the motor 26 and/or functional component 25 (e.g., the operating the speed of the motor 26 and/or blower 25 and/or for controlling the rate of forward or rearward movement of the apparatus 20). By pivoting the control head 30 from side to side in directions A or B, the post-like support 31 also pivots and causes the steerable wheel 24 to turn the apparatus 20 in the same direction (when moving forward). This allows an operator 28 standing on a platform 33 on the frame 21 (the operator being positioned immediately adjacent and rearward of the support 31) to lean into a corner (by flexing one or both of his knees and shifting his weight) when steering the apparatus 20. In other words, the apparatus 20 is steered by moving the control head 30 laterally, thus steering the apparatus 20 into the corner while the operator simultaneously leans into the corner for balance and while the operator also continues to control operation of the one blower via the control handle 32. I′ve found that the present method of lean-into steering makes the apparatus 20 easier to steer, intuitive to steer, more ergonomic to steer, and actually fun to steer. Further, the rear-steering allows the apparatus to make quick, tight, well-controlled turns around obstacles.

The frame 21 (FIG. 1) includes tubular side frame members 60 supporting a front box frame 61 on which the motor 26 and the functional component (blower 25) are mounted or supported. The frame members 60 extend rearward, and support the platform 27 and a rear frame component 62 with arm 63 supporting a wheel pivot 64. The frame members 60 include ends 65 that extend on either side of the rear steerable wheel 24 for protecting the wheel 24 and the components of the steering mechanism 29. The rear steerable wheel 24 includes an inverted U-shaped wheel frame 66 supporting a wheel axle, the wheel frame 66 including an internal post and bearing 67 rotatably engaging the wheel pivot 64.

The illustrated motor 26 is a self contained gas engine with air intake, pull start, gas tank, and etc. It is contemplated that the motor 26 can be electrical start if desired. The box frame 61 includes a raised top plate 70 on which the motor 26 is mounted. A transmission 71 is mounted under the top plate 70 for driving the axle 72 of front wheels 22 and 23. The illustrated hand crank 74 is connected to a brake on the axle 72 (or to the transmission 71), and extends upwardly through the top plate 70.

The illustrated blower 25 is mounted to a front of the motor 26, anchored to the box frame 61 and connected to a drive shaft of the motor 26. The blower 25 includes a blower housing 74′, an internal blower blade(s), a blower output hose 75, and front air intake (not specifically shown). It is contemplated that different blowers and blower options can be included, such as deflectors and controls for adjustably pointing the blower output hose in a desired adjustable direction(s). It is also contemplated that the blower can be modified to work as a vacuum source, such as for collecting leaves and debris. It is also contemplated that different functional components can be mounted to the apparatus 20 instead of a blower, such as lawn aerating devices, mowers, choppers, and the like.

The illustrated post support 31 of the steering mechanism 29 comprises a square tube supporting the control head 30 at a height suitable for a standing operator of the apparatus 20, such as about waist high or in other words about 36-48 inches above the platform 27. The illustrated post support 31 is fixed, but it is noted that the post support 31 and/or the control head 30 can be made height adjustable if desired. The post support 31 includes a top portion 78 supporting the control head 30, a mid portion 79 supporting a pivot 80 and a lower portion 81 attached to cables in the steering mechanism 29. The frame 21 includes a fixed support post 82 with a bearing 83 at its top for pivotally engaging the pivot 80. The fixed support post 82 locates the pivot 80 at about knee high or slightly lower, such as 10-18 inches. A lower pivot location provides increased leverage for making turns, but provides shorter turn strokes. The overall design can be constructed to provide the desired leverage and stroke for optimal turning.

The control head 30 (FIG. 1) is box shaped and includes a bottom panel 85, front panel 86, and side panels 87-88. Front and rear grips 89 and 90 have an inverted V-shape and are made of bent tubular rods 92 fixedly attached to the side panels 87 and 88 at front and rear spaced locations. Center control handles 32 and 32A are end portions of a bent tubular rod located between and pivoted to the side panels 87 and 88 at aligned locations 93. The handles 32/32A are L-shaped members connected by a transverse rod member extending along the axis of rotation of location 93, and include upright sections 94 and end-coverings forming grips for the handles 32 and 32A. A bracket 98 is fixed to and extends radially/rearwardly from the transverse rod member, and its outer end is connected to a cable 99 for lifting the cable 99 when the handle 32 (or 32A) is rotated forward, and for lowering the cable 99 (with spring assist) when the handle 32 (or 32A) is rotated rearward. The cable assembly 100 includes a cable sleeve 101 fixedly connected to the frame, such as at a top location to the bottom panel 85 and at one or more lower locations, such as at the mid-bracket 103 on the post support 31 and/or at a bottom to the frame 21, such as to box frame 61. The cable 99 extends internally through the sleeve 101 and operably connects to the motor or transmission or functional component for controlling same. The illustrated cable 99 is connected at its lower end to an arm of an L-shaped pivoting lever 105. The lever 105 is pivoted at a center point and also connected at its opposite end to a rod 106 that extends to the transmission, where it controls a clutch or belt or transmission mechanism for causing the transmission to engage to move the apparatus 20 forwardly (if the rod is moved forwardly), or for causing the transmission to engage to move the apparatus rearwardly (if the rod is moved rearwardly).

The steering mechanism 29 and overall arrangement allows a standing rider/operator to grab the fixed grip 88 and/or fixed grip 89 and also grab one of the drive-control grips 32/32A. By squeezing, the rider can easily and accurately control forward or rearward rotation of the control rod 92. As illustrated, the control handle/rod 92 is operably connected to the transmission 71, so that forward movement of the handle 32 or 32A causes the apparatus 20 to move forward with increasing speed, and rearward movement of the control handle 32 or 32A causes the apparatus 20 to move rearward with increasing speed. When the handle control handle 32 or 32A is in its centered position, the apparatus 20 stops (i.e., remains stationary, such as be releasing the motor from a driving state as well as applying a brake).

Additional controls and handles can be mounted to the control head 30. For example, a throttle handle 32B is pivoted to the bottom panel 85 and operably connected to the motor 26 for pivoting forward to increase motor rpm, or pivoting rearward to decrease motor rpm. The throttle handle 32B is connected to a cable assembly having an outer sleeve 110 attached to the bottom panel 85 and to another location on the frame 21. An inner cable 111 extends through sleeve 110 and is connected to the handle 32B at one end and to the motor throttle (not specifically shown) of the motor 26. Notably, a brake crank handle 74 is shown extending upwardly through the box frame 61. However, it could also be positioned on the control head 30 if desired, along with other features, such as a blower control, blower angle controls, etc.

The steering mechanism 29 includes the control head 30 and post support 31 as described above. Further, the steering mechanism 29 (FIG. 1) includes right and left cables operably connected to the steerable rear wheel 24 as follows. The right cable 115 is connected to a lower end of the post support 31 and extends to the right around a cable wheel 116 rotatably supported by a bracket on the frame 21, and then extends rearward under the platform 27 (in a protected position) to the rear wheel 24. The rear wheel 24 includes arc brackets 118 attached on either side of the wheel frame 66, and the end of the cable 115 is attached to the arc bracket 118. When cable 115 is tensioned, it pulls on the associated arc bracket 118, which provides a constant torque arm on the wheel frame 66 sufficient to turn the rear steerable wheel 24 in that direction. Notably, when the rear steerable wheel 24 is rotated so that it rolls forward toward a left side of the frame 21, the frame 21 turns toward the right (since the rear wheel tracks toward and takes a rear of the frame 21 initially toward the left).

The steering mechanism 29 also includes a left cable 115A that is connected to a lower end of the post support 31 and extends to the left around a cable wheel 116A rotatably supported by a bracket on the frame 21, and then extends rearward under the platform 27 (in a protected position) to an opposite side of the rear wheel 24. The rear wheel 24 includes another arc bracket 118 attached to an opposite side of the wheel frame 66, and the end of the cable 115A is attached to the arc bracket 118. When cable 115A is tensioned, it pulls on the associated arc bracket 118A, which provides a torque arm on the wheel frame 66 sufficient to turn the rear steerable wheel 24 in that direction. Notably, when the rear steerable wheel 24 is rotated so that it rolls forward toward a right side of the frame 21, the frame 21 turns toward the left (since the rear wheel tracks toward and takes a rear of the frame 21 initially toward the right).

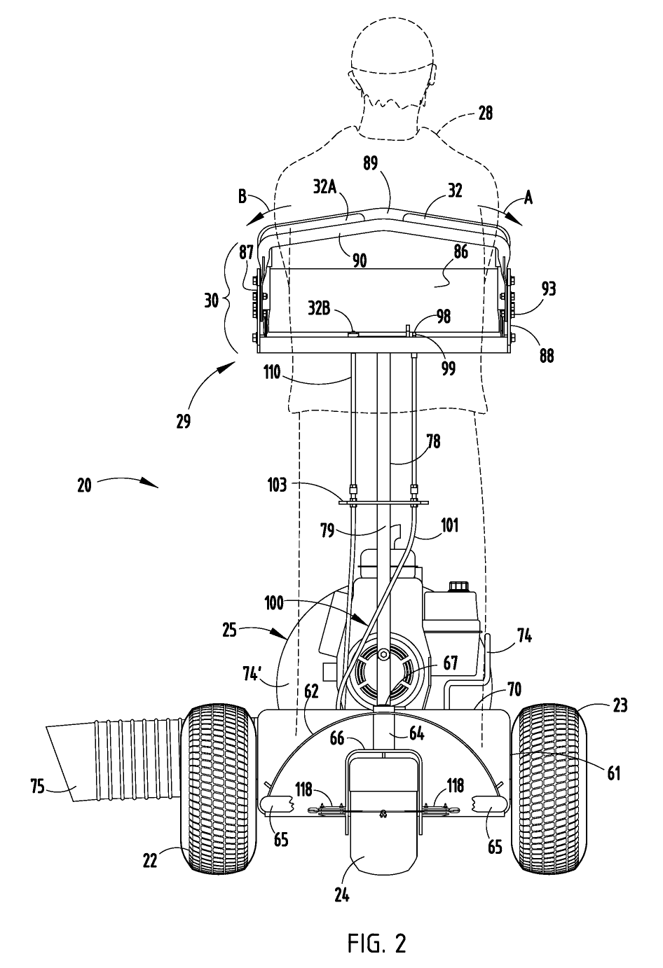

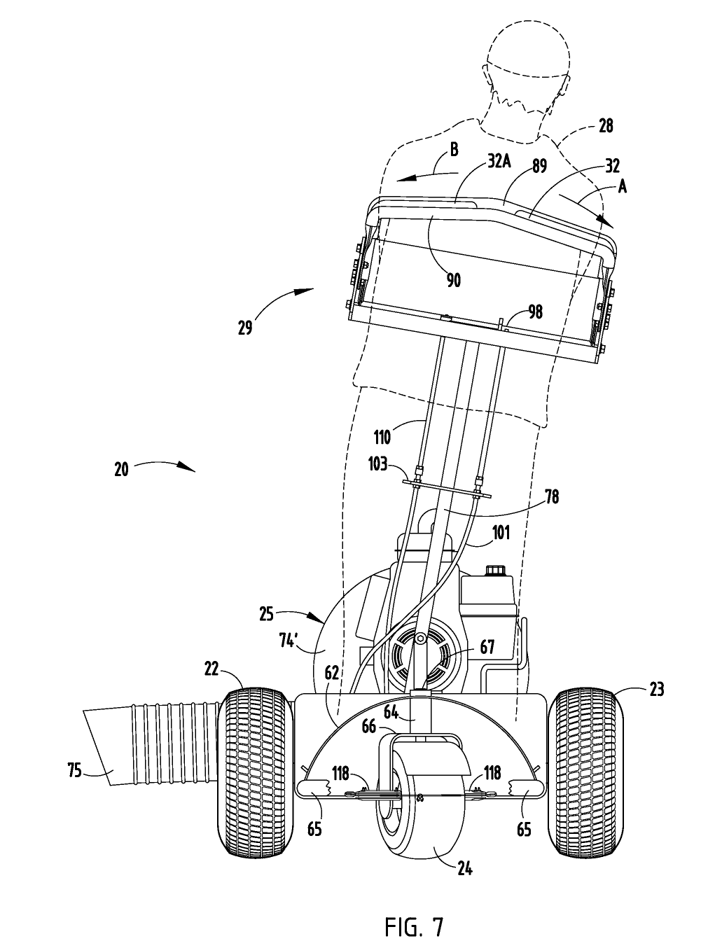

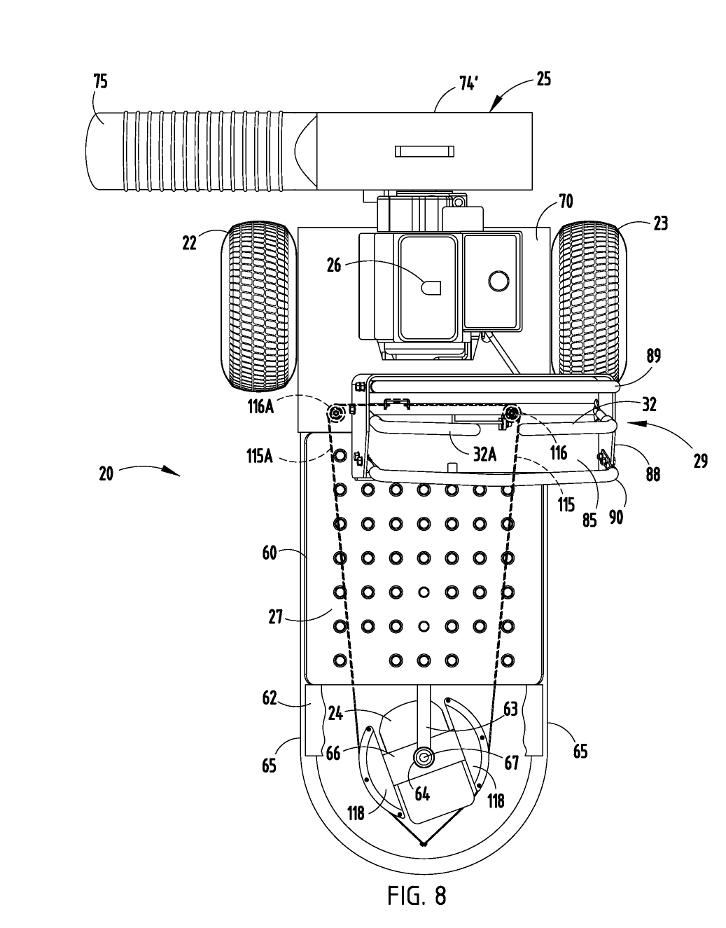

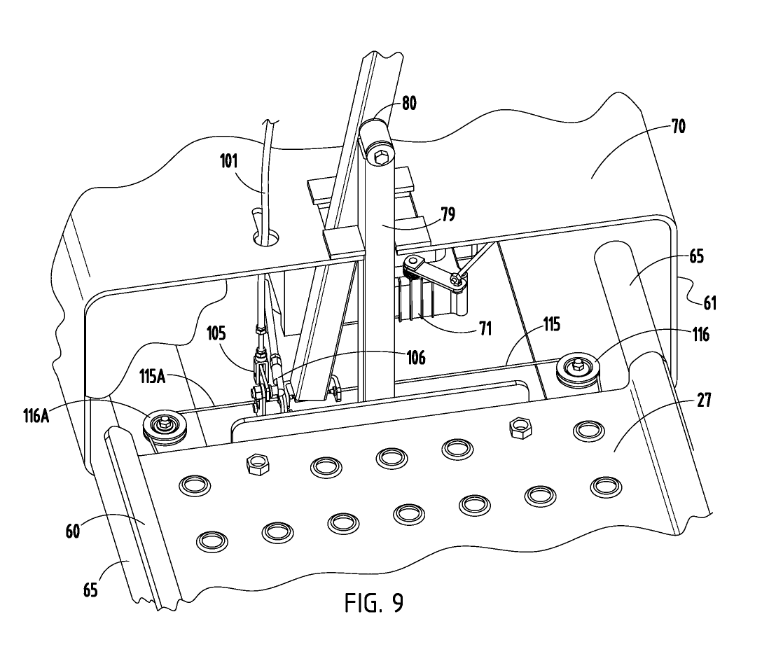

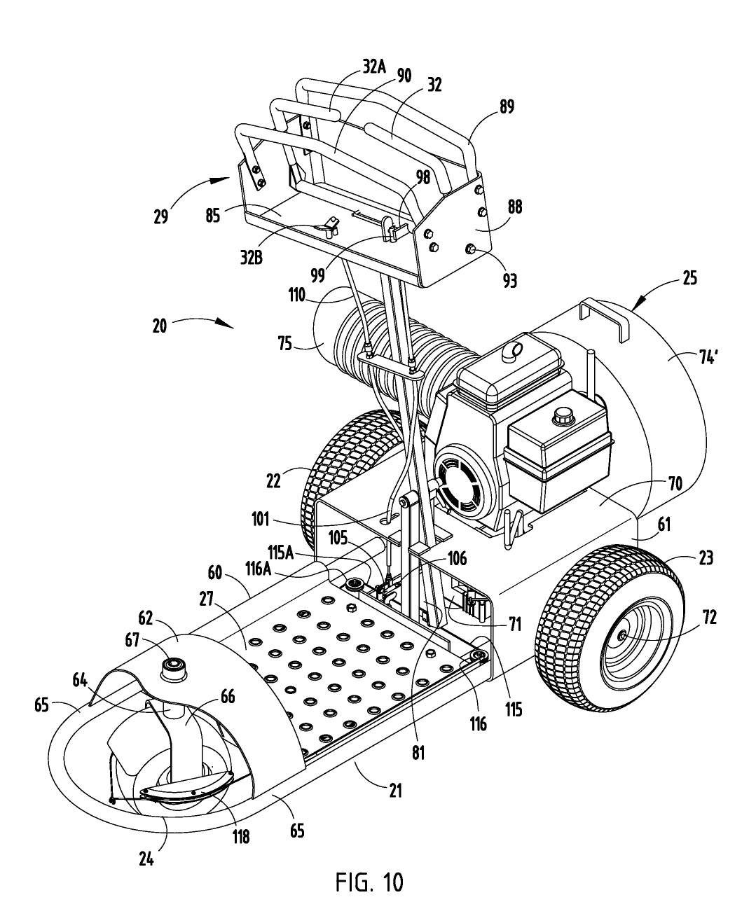

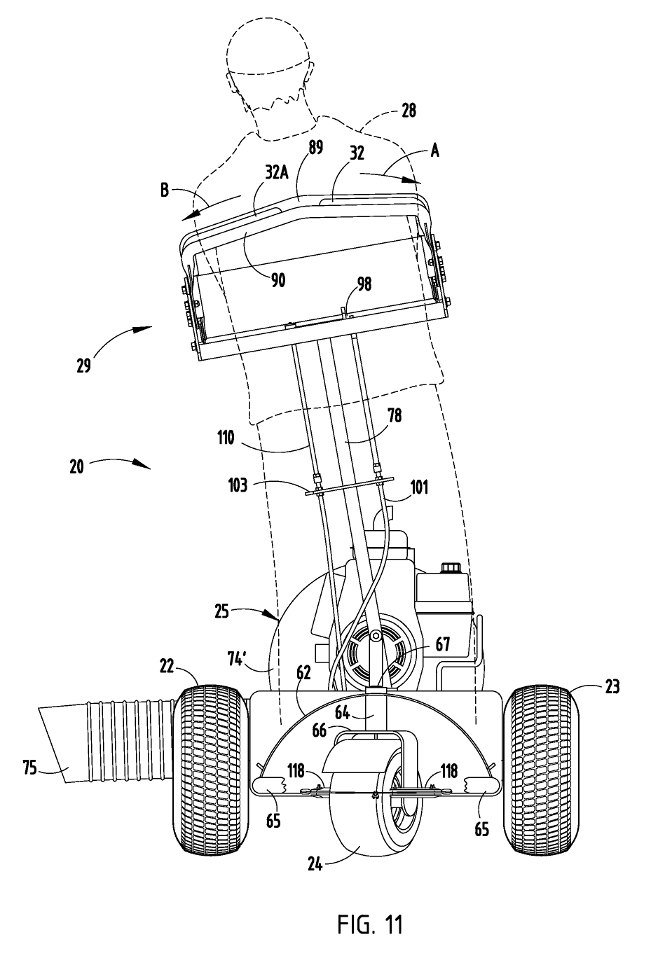

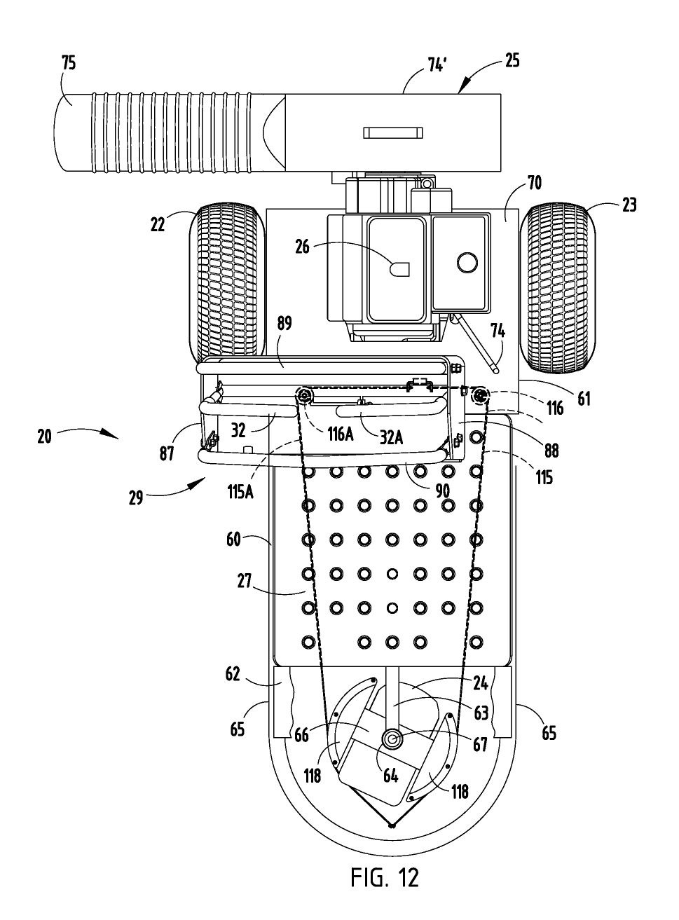

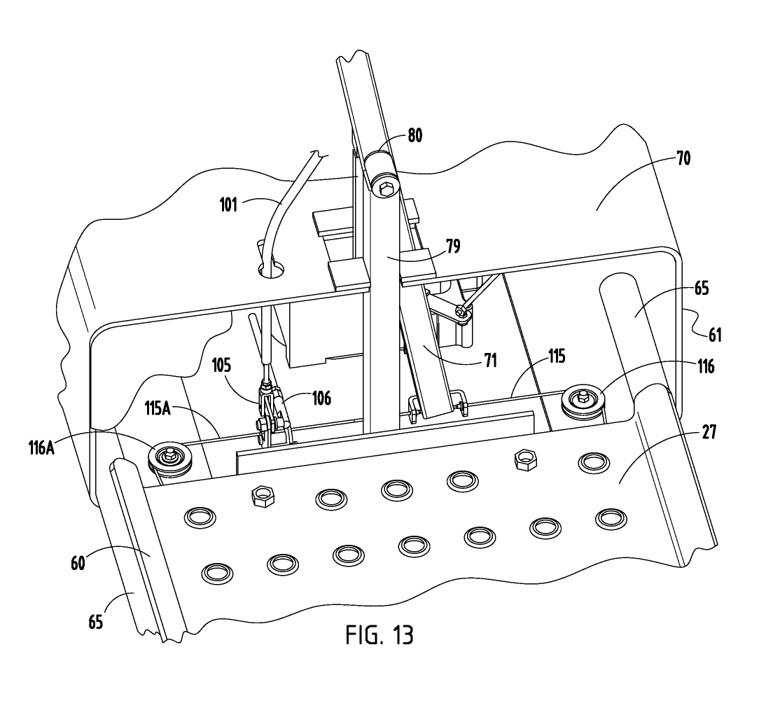

The method of steering is shown by comparing the operator 28 standing in FIG. 2 (straight movement), leaning toward the right in FIG. 7 (steering toward the right when moving forward), and leaning toward the left in FIG. 11 (steering toward the left when moving forward). As can be seen, steering is accomplished in part by simply leaning into a corner, which results in an intuitive and “fun” sense of steering, sometimes referred to as “lean-into steering.” The operator 28 may bend the “leading knee” as the operator 28 leans into the corner, or the operator 28 may otherwise shift their weight, depending on a sharpness and quickness of the turn, levelness of the ground, and other factors affecting the turn. Notably, the operator 28 continues to hold onto the control head 30 through the turn (such as by continuing to hold one or more of the grips 88, 89, 32, 32A). In fact, the operator continues to be able to manipulate any of the controls on the control head 30 during the turn, thus allowing an increased level of control even while continuing to make multiple and constantly changing turns. This allows the operator to makes adjustments for an improved work product, such as slowing down to allow a more complete blowing action where close bushes make it necessary to spend additional time blowing leaves into or through the bushes. It is noted that the present “lean-into” steering feels much like the steering of Segway™ two-wheel personal transport vehicles.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A self-powered ride-on apparatus, comprising:
a frame with at least two fixed-axis wheels and at least one steerable wheel;
a functional component and a motor component supported on the frame;
a platform on the frame adapted to support a riding operator; and
a steering mechanism including a control head and a pivoted support supporting the control head, the control head including a handle constructed and operably connected to one of the functional component and the motor component and adapted to control operation of at least one aspect of the one component; the support being pivoted to the frame for side to side movement about an axis of rotation extending forwardly and generally horizontally, the support including an upper first portion supporting the control head, a second portion pivoted to the frame and defining the axis of rotation in a location spaced from the control head, and a third portion spaced from the second portion and operably connected to the steerable wheel for steering same so that by moving the head laterally, steering of the steerable wheel is controlled; whereby an operator standing on the frame and positioned immediately adjacent the support can control steering of the equipment by the side to side movement of the support while also controlling operation of the one component via the handle.

2. The apparatus of claim 1, wherein the functional component is located on a front of the frame.

3. The apparatus of claim 1, wherein the functional component is a blower.

4. The apparatus of claim 1, wherein the functional component is a lawn care device for treating and providing care to a grassy lawn.

5. The apparatus of claim 1, wherein the at least one steerable wheel is a rear wheel.

6. The apparatus of claim 1, wherein the support is a post that is generally centered on the frame.

7. The apparatus of claim 1, wherein the steering mechanism includes a linkage that in part connects the support to the steerable wheel.

8. The apparatus of claim 1, wherein the steering mechanism includes at least one cable that in part connects the support to the steerable wheel.

9. The apparatus of claim 8, wherein the at least one cable includes a first cable that when tensioned causes steerable wheel to turn left and a second cable that when tensioned causes steerable wheel to turn right.

10. The apparatus of claim 8, wherein at least part of one cable extends under the platform.

11. A self-powered ride-on apparatus comprising:
a wheeled frame having at least one steerable wheel and constructed to support a ride-on standing operator; and
a steering mechanism on the wheeled frame, the steering mechanism including a support pivoted to the frame for side to side movement and a control head at a top of the support, the control head including controls for controlling a function of the apparatus, the support having a length positioning the control head and controls for grasping by the standing operator, the support being operably connected to the at least one steerable wheel so that the side to side movement of the support causes the at least one steerable wheel to change a direction of rolling movement, whereby the standing operator can control steering of the equipment by moving the control head from side to side while also simultaneously operating the controls.

12. The apparatus of claim 11, including a motor and a functional component both supported on the frame and operably connected to each other and also to the control head for control.

13. The apparatus of claim 12, wherein the functional component is a blower.

14. The apparatus of claim 11, wherein the at least one steerable wheel is a rear wheel.

15. The apparatus of claim 11, wherein the post is generally centered on the frame.

16. The apparatus of claim 11, wherein the steering mechanism includes a linkage that in part connects the support to the steerable wheel.

17. The apparatus of claim 11, wherein the steering mechanism includes at least one cable that in part connects the support to the steerable wheel.

18. The apparatus of claim 17, wherein the at least one cable includes a first cable that when tensioned causes steerable wheel to turn left and a second cable that when tensioned causes steerable wheel to turn right.

19. A self-powered ride-on apparatus comprising:
a wheeled frame having at least one rear-located steerable wheel, a pair of fixed-axis front wheels, and a platform for a ride-on standing operator;
a motor on the frame and a functional component on a front of the frame that is operably connected to the motor; and
a control head on the frame operably connected to the at least one steerable wheel and that changes a direction of rolling movement of the at least one steerable wheel when the control head is shifted laterally from side to side on the wheeled frame.

20. The apparatus of claim 19, wherein the functional component is a blower.

21. The apparatus of claim 19, wherein the at least one steerable wheel includes a single steerable wheel.

22. An outdoor self-powered apparatus comprising:
a wheeled outdoor self-powered equipment including a frame with a place for an operator to stand, a steering mechanism, at least one steerable wheel and a functional component; and
the steering mechanism including a support pivoted to a frame at a pivot location generally adjacent a knee of the operator when standing thereon and including an upper end with a place for the operator to grip, and including a lower end connected to the at least one steerable wheel, whereby the operator can control steering by leaning into a corner while simultaneously moving the upper end of the support toward the corner, thus creating a stable lean-into type steering action for steering the apparatus.

23. A method of steering and controlling an apparatus comprising:
providing a wheeled outdoor self-powered equipment including a frame with a place for an operator to stand, a steering mechanism, at least one steerable wheel and a functional component; the steering mechanism including a support pivoted to a frame generally adjacent a knee of the operator when standing thereon and including an upper end with a place for the operator to grip, and including a lower end connected to the at steerable wheel; and
steering by the operator leaning into a corner while simultaneously moving the upper end of the support toward the corner, thus creating a stable lean-into type steering action for steering the apparatus.
